(19) United States
(12) Patent Application Publication
(10) Pub. No.: US 2011/0277612 A1
(43) Pub. Date: Nov. 17, 2011

(54) BI-DIRECTIONAL CUTTING SAW BLADE

(76) Inventor: CHUNG-KUANG CHEN, Taichung City (TW)

(21) Appl. No.: 12/778,471

(22) Filed: May 12, 2010

(51) Int. Cl. B27B 33/08; B23D 61/02

(52) U.S. Cl. 83/837; 83/848

(57) ABSTRACT

A bi-directional cutting saw blade, capable of produce a cutting effect in both directions of forward and reverse rotation as it has cutting edges disposed on leading and trailing rims of each saw tooth. An unsharpened obtuse angle of the trailing cutting edge of the saw tooth can scrape off burrs and debris of a cut. When a trailing cutting edge of a saw tooth is in a cut, a leading cutting edge of a next saw tooth has cut into the workpiece, so that the saw blade does not offset from the cutting direction when cutting a workpiece. In the application to a pair of dual saw blades, salient points are disposed on one of the saw blades so that the dual saw blades are coaxially and tightly spaced, thereby reducing frictional heat produced in the cutting operation, preventing deformation of the saw blades, and enhancing the cutting effect.

### BACKGROUND OF THE INVENTION

1. Field of Invention

The present invention relates to a bi-directional cutting saw blade, on which leading and trailing rims of each saw tooth are both provided with cutting edges, so that the two cutting edges of the saw tooth can respectively perform a cutting operation in two different assembly directions; besides, non-cutting trailing cutting edges produce a cut cleaning effect when the saw blade cuts a workpiece.

2. Related Art

A saw blade includes a saw blade body and cutting edges disposed on the saw blade body. Saw teeth are formed on the periphery of the saw blade body, and the cutting edges are securely disposed on the saw teeth. A cut is opened by cutting an object with the cutting edges. After the circular saw blade is used for a period of time, the cutting edges are inevitably damaged first, and the saw blade is out of use and must be discarded upon damage of the cutting edges. The fabrication cost of the saw blade body of the circular saw blade is much higher than that of the saw teeth. Whenever the low cost cutting edges are damaged, the sound saw blade body must be discarded together, which causes waste of resources as well as unforgotten pain of users.

The saw blade may have two kinds of saw teeth according to the number of saw teeth, i.e., coarse saw teeth with a small number which provide fast cutting but result in rough cut surfaces, and fine saw teeth with a large number which provide slow cutting but result in smooth cut surfaces. This phenomenon is especially apparent for wooden materials. The choice of either kind of saw blade is in a dilemma. Saw teeth of a common circular saw blade with unidirectional saw teeth are usually coarse saw teeth producing rough kerfs.

Many designs or documents directed to this phenomenon have been provided in the prior art, which mainly emphasize, or are limited to, the mere improvement of a unidirectional saw blade used alone or use in combination including installation of a spacer to improve a gap of saw blades, as shown below.

The invention of US Patent No. US 2004/0182217 A1 or WO 2008/057027 relates to a pair of oppositely rotating saw blades having unidirectional saw teeth, in which the saw blades are assembled pairwise with a certain circumferential spacer at a position designed at sides of the saw blades. The formation of such saw teeth requires complex lathe and milling machining, which poses an obvious disadvantage in manufacturing of the saw blades. Meanwhile, high heat is resulted from a relatively large frictional contact surface formed in the use of the saw teeth, which is detrimental and adversely affects the saw blades, and in turn, the cutting operation. When operating under load, the saw blades may develop metal fatigue and cracks due to metallic property alteration caused by thermal energy in the cut area, resulting in a shorter service life of the saw blades.

U.S. Pat. No. 4,641,562 relates to two circular saw blades of different sizes that operate with differently sized saw teeth and are mounted coaxially adjacent to one another. When used for cutting, the large saw blade first makes a rough cut, and the small saw blade follows the path formed ahead to provide a smooth finished cut. The use of such a pair or set of counter-cutting and oppositely rotating saw blades is not only technically impractical but also difficult in fabrication.

U.S. Pat. No. 4,133,240 emphasizes a circular saw blade of unidirectional saw teeth, and improved saw tooth angles and low cut points which decide inclinations or angles of saw planes of cutting edges and are alternatively arranged along the rim of a specially designed circular saw, and thus substantially improved saw blade performance is provided, particularly in the area of wear of the saw blade.

### SUMMARY OF THE INVENTION

Accordingly, the present invention is directed to a bi-directional cutting saw blade, having a cutting edge disposed on leading and trailing rims of each saw tooth and thus capable of performing cutting in two directions respectively, so as to prolong the service life of the saw blade.

The present invention is directed to a bi-directional cutting saw blade, capable of cleaning up burrs and debris of a cut to form a smooth cut while cutting a workpiece.

The present invention is further directed to a bi-directional cutting saw blade, having the function of guiding a cutting direction to make a cut more smooth.

The present invention provides a bi-directional cutting saw blade, having a plurality of protruding and equiangularly spaced saw teeth disposed along a rim of a saw blade body. A cutting edge is securely disposed in a front-to-rear corresponding form on leading and trailing rims of each saw tooth of the saw blade, so that the saw blade is capable of producing a cutting effect in both forward and reverse rotations.

The present invention provides a bi-directional cutting saw blade, in which a leading cutting edge of a saw tooth of the saw blade forms a rough cut by cutting, while an unsharpened obtuse angle (or right angle) of a trailing cutting edge of the saw tooth scrapes off burrs and debris of the cut to make the cut smooth.

The present invention provides a bi-directional cutting saw blade, in which when a trailing cutting edge of a previous saw tooth of the saw blade is still in a cut, a leading cutting edge of a next saw tooth has cut into the workpiece, so that the saw blade does not offset from the cutting direction when cutting a workpiece.

### BRIEF DESCRIPTION OF THE DRAWINGS

The present invention will become more fully understood from the detailed description given herein below for illustration only, and thus are not limitative of the present invention, and wherein:

FIG. 1 is an outside view of an embodiment of the present invention;

FIG. 2 is a front view of a first saw blade in FIG. 1;

FIG. 3 is a front view of a second saw blade in FIG. 1;

FIG. 4 is an enlarged cross-sectional view of the embodiment shown in FIG. 1; and

FIG. 5 is a schematic view of another embodiment of salient points on the first saw blade.

### DETAILED DESCRIPTION OF THE INVENTION

In view of the problem that a unidirectional cutting saw blade is discarded when cutting edges are worn out, thereby causing waste, the Applicant provides a bi-directional cutting saw blade, capable of prolonging the service life of the saw blade by 100% and providing a smooth cut surface of a workpiece and thus improving the cutting quality.

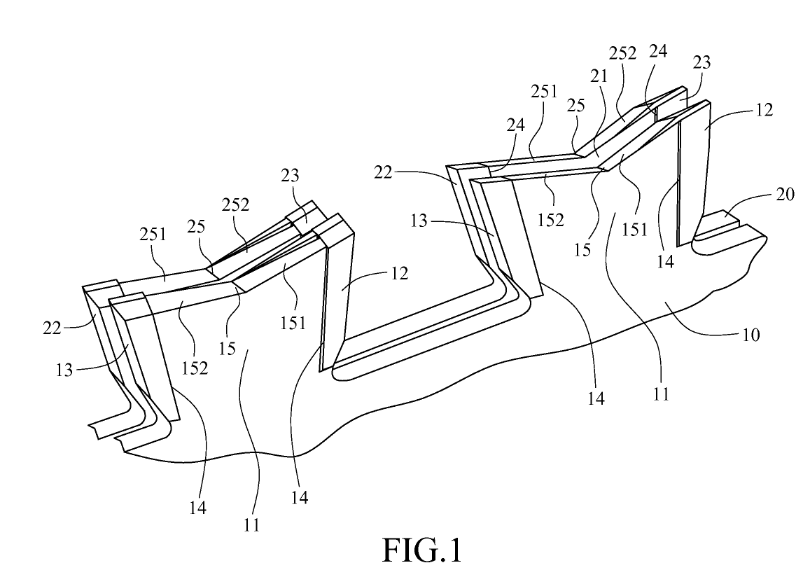

The bi-directional cutting saw blade disclosed in the present invention may be a pair of bi-directional cutting circular saw blades 10 and 20, as shown in FIG. 1. The pair of circular saw blades 10 and 20 is coaxially mountable on a cutting device (not shown), and moves in opposite directions and performs coaxial counter-cutting relative to each other. The cutting device is an electric saw in which two circular saw blades respectively performing forward rotation and reverse rotation may be assembled.

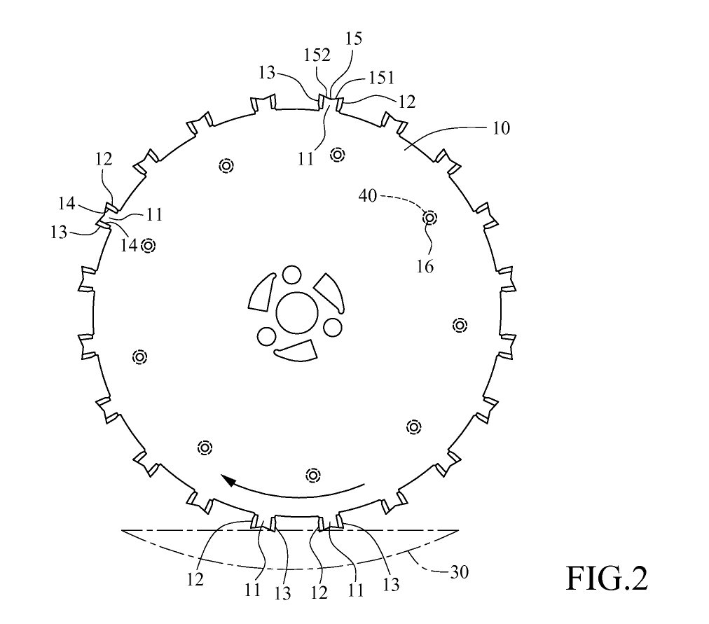

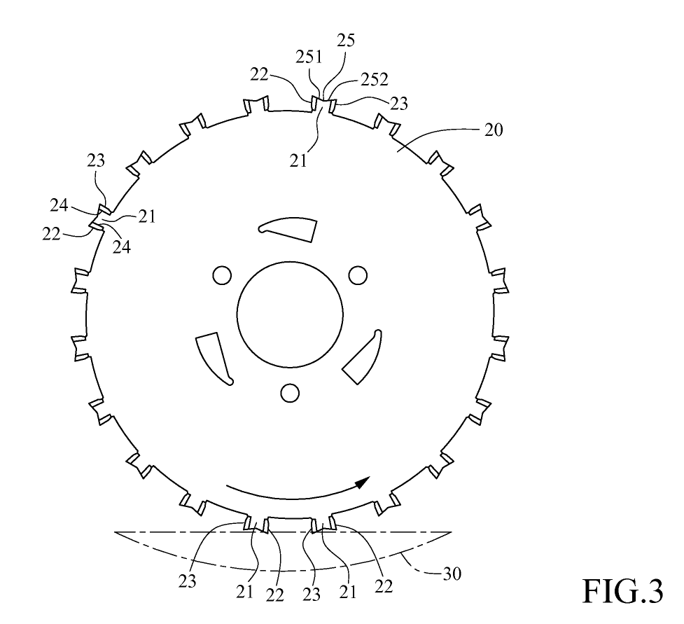

With reference to FIGS. 2 and 3, the pair of circular saw blades includes a first saw blade 10 and a second saw blade 20. The first saw blade 10 and the second saw blade 20 are respectively provided with a plurality of protruding and equiangularly spaced saw teeth 11 and 21 along rims of saw blade bodies. A cutting edge 12, 13 is securely disposed in a front-to-rear corresponding form on leading and trailing rims of each saw tooth of the first saw blade 10, so that the first saw blade 10 is capable of producing a cutting effect on a workpiece 30 in both forward and reverse rotations. A cutting edge 22, 23 is securely disposed in a front-to-rear corresponding form on leading and trailing rims of each saw tooth 21 of the second saw blade 20, so that the second saw blade 20 is capable of producing a cutting effect on the workpiece 30 in both forward and reverse rotations.

The above first saw blade 10 performs forward rotation (clockwise rotation) on the cutting device, so that the cutting edge 12 of the saw tooth 11 thereof first in contact with the workpiece 30 is a leading cutting edge 12, while the other cutting edge 13 is a trailing cutting edge 13. The second saw blade 20 performs reverse rotation (counterclockwise rotation) on the cutting device, so that the cutting edge 22 of the saw tooth 21 thereof first in contact with the workpiece 30 is a leading cutting edge, while the other cutting edge 23 is a trailing cutting edge 23.

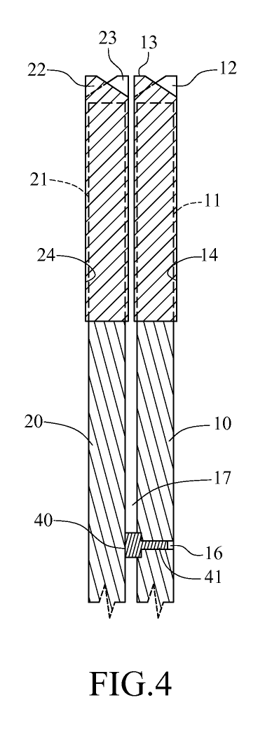

With reference to FIGS. 2 and 4, at least three equiangularly spaced salient points 40 are disposed on the saw blade body of the above first saw blade 10. In this embodiment, the number of the salient points 40 is nine. The salient points 40 are in the same circle. Top ends of the salient points 40 are in contact with the second saw blade 20, so that a gap 17 is formed between the first saw blade 10 and the second saw blade 20. With the salient points 40, the friction of the contact surface between the first saw blade 10 and the second saw blade 20 is small and the temperature does not rise too high, so that the two saw blades 10 and 20 may not be softened due to overheat, thereby enhancing the cutting precision and prolonging the service life of the saw blades 10 and 20. A perforation 16 is disposed at a position on the first saw blade 10 where the salient point 10 is disposed, a rivet 41 is fixed at the perforation, and a head 40 of the rivet 41 forms the salient point 40.

When the leading cutting edges 12, 22 in the above first saw blade 10 or second saw blade 20 are worn out and affect the cutting effect, the two saw blades 10 and 20 may be taken down from the cutting device and mounted reversely, so as to use the trailing cutting edges 13 and 23 of the two saw blades 10 and 20 for cutting. The rivets 41 on the first saw blade 10 must be taken down by striking and driven into the perforations 16 again on the other surface, so that the heads 40 of the rivets 41 form salient point 40 on the other surface of the first saw blade 10. A gap is formed between the reversely used first saw blade 10 and second saw blade 20 with the salient points 40. Therefore, the service life of the first saw blade 10 and the second saw blade 20 having dual cutting edges 12, 13, 22, 23 is twice that of a conventional saw blade having unitary cutting edges.

A thickness of the cutting edges 12, 13, 22, 23 of the first saw blade 10 and the second saw blade 20 is slightly greater than that of the saw teeth 11 and 21, so that an unsharpened obtuse angle 14, 24 (or right angle) is formed at connections between the cutting edges 12, 13, 22, 23 and the saw teeth 11 and 21. When the first saw blade 10 and the second saw blade 20 are used to cut the workpiece 30, the leading cutting edge 12, 22 of each saw tooth 11, 21 of each saw blade 10, 20 performs an operation of cutting the workpiece 30, while the trailing cutting edge 13, 23 is capable of producing a non-cutting scraping effect on a cut surface with the unsharpened obtuse angle 14, 24 and the side face to clean up burrs and debris, so as to form a cut as a smooth surface.

In the above, a recessed notch 15, 25 is disposed at the center of an outer rim of each saw tooth 11, 21 of the first saw blade 10 and the second saw blade 20, so that the saw tooth 11, 21 is shaped like a dovetail. Two sidewalls 151, 152, 251, 252 of the notch 15, 25 are respectively guide surfaces when the leading and trailing cutting edges 12, 13, 22, 23 of the saw tooth 11, 21 cut the workpiece.

With reference to FIG. 2, in cutting of the workpiece 30 by the first saw blade 10, when the leading cutting edge 12 of a previous saw tooth 11 leaves the cut, the trailing cutting edge 13 thereof is still in the cut. At this time, the leading cutting edge 12 of a next saw tooth 11 has cut into the workpiece 30, so that the first saw blade 10 does not offset from the cutting direction when cutting the workpiece 30. Similarly, the second saw blade 20 also does not offset from the cutting direction when cutting the workpiece 30, as shown in FIG. 3.

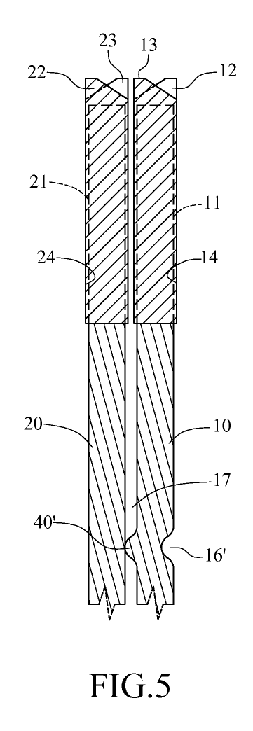

With reference to another embodiment in which salient points 40′ are formed on the first saw blade 10 as shown in FIG. 5, the salient points 40′ on the first saw blade 10 are formed by punching and hollowing, so that the salient point 40′ are formed on one end face of the body of the saw blade 10, and recessed holes 16′ are formed correspondingly on an other end face. The saw blades 10 and 20 shown in FIG. 5 are assembled on a cutting device having a forward and reverse rotating motor (not shown). When the leading cutting edges 12 and 22 of the saw teeth 11 and 21 of the first saw blade 10 and the second saw blade 20 are worn out, the cutting device may directly change the rotation direction of the motor, so as to enable the trailing cutting edges 13 and 23 of the saw teeth 11 and 21 of the first saw blade 10 and the second saw blade 20 to perform the cutting operation. Therefore, by switching between the forward and reverse rotations of the motor of the cutting device, the first saw blade 10 originally performing forward rotational cutting is changed to reverse rotational cutting, and the second saw blade 20 originally performing reverse rotational cutting is changed to forward rotational cutting without reversely mounting the saw blades 10 and 20 as shown in FIG. 5, which is more simple and convenient in operation.

A single circular saw blade and a strip saw blade (linear saw blade) may also be used in the dual cutting edge design of the present invention. When a single saw blade (not shown) is mounted on a cutting device (not shown), the cutting operation can be performed with trailing cutting edges as long as the saw blade is assembled on the other surface. The above cutting device may be a circular saw machine or another manual or power machine tool such as an electric saw, a wire saw, a hand saw, or a bow saw.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A pair of bi-directional cutting circular saw blades, coaxially mountable on a cutting device and moving in opposite directions and performing coaxial counter-cutting relative to each other, wherein
the pair of circular saw blades is respectively provided with a plurality of protruding and equiangularly spaced saw teeth along rims of saw blade bodies, and a cutting edge is securely disposed in a front-to-rear corresponding form on leading and trailing rims of each saw tooth of each saw blade, so that the circular saw blades are capable of producing a cutting effect in both forward and reverse rotations.

2. The pair of bi-directional cutting circular saw blades according to claim 1, wherein at least three equiangularly spaced salient points are disposed on the saw blade body of one circular saw blade, and top ends of the salient points are in contact with the other circular saw blade.

3. The pair of bi-directional cutting circular saw blades according to claim 2, wherein the salient points on the saw blade body of the circular saw blade are formed by punching, so that the salient point are formed on one end face of the saw blade body, and recessed holes are formed correspondingly on an other end face.

4. The pair of bi-directional cutting circular saw blades according to claim 2, wherein a perforation is disposed at a position on the saw blade body of the circular saw blade where the salient point is disposed, a rivet is fixed at the perforation, and a head of the rivet forms the salient point.

5. The pair of bi-directional cutting circular saw blades according to claim 1, wherein a recessed notch is disposed at a center of an outer rim of each saw tooth of each saw blade, so that the saw tooth is shaped like a dovetail, and two sidewalls of the notch are respectively guide surfaces when leading and trailing cutting edges of the saw tooth cut a workpiece.

6. The pair of bi-directional cutting circular saw blades according to claim 1, wherein in leading and trailing cutting edges of each saw tooth of each saw blade, one cutting edge performs an operation of cutting a workpiece, while the other cutting edge is capable of producing a non-cutting scraping effect on a cut surface with an unsharpened obtuse angle and a side, so as to form a smooth cut.

7. A bi-directional cutting saw blade, having a plurality of protruding and equiangularly spaced saw teeth disposed along a rim of a saw blade body, wherein a cutting edge is securely disposed in a front-to-rear corresponding form on leading and trailing rims of each saw tooth of the saw blade, so that the saw blade is capable of producing a cutting effect in both forward and reverse rotations.

8. The bi-directional cutting saw blade according to claim 7, wherein a recessed notch is disposed at a center of an outer rim of each saw tooth of the saw blade, so that the saw tooth is shaped like a dovetail, and two sidewalls of the notch are respectively guide surfaces when leading and trailing cutting edges of the saw tooth cut a workpiece.

9. The bi-directional cutting saw blade according to claim 7, wherein in leading and trailing cutting edges of each saw tooth of the saw blade, one cutting edge performs an operation of cutting a workpiece, while the other cutting edge is capable of producing a non-cutting scraping effect on a cut surface with an unsharpened obtuse angle and a side, so as to form a smooth cut.
